(19) United States
(12) Patent Application Publication
(10) Pub. No.: US 2011/0011912 A1
(43) Pub. Date: Jan. 20, 2011

(54) AUTO HAMMER

(75) Inventors: Gan Wei, Jiangsu (CN); Masatoshi Fukinuki, Jiangsu (CN)

Correspondence Address: GREENBERG TRAURIG, LLP, 77 WEST WACKER DRIVE, SUITE 3100, CHICAGO, IL, 60601-1732, US

(73) Assignee: Chervon Limited, Wanchai (CN)

(21) Appl. No.: 12/700,018

(22) Filed: Feb. 4, 2010

(30) Foreign Application Priority Data
Jul. 17, 2009 (CN) 200920233241.5

(51) Int. Cl. B25C 1/00; B25C 7/00

(52) U.S. Cl. 227/113

(57) ABSTRACT

An auto hammer has a housing body and a nozzle portion connected to the housing. The housing body contains a striking device therein. The nozzle portion contains a sleeve and a sleeve support. The sleeve is retractable within the sleeve support and contains a nail attracting device therein. A magnet is arranged in the nail attracting device and is supported by at least one spring. The nail attracting device of the auto hammer is thus arranged in the sleeve and the spring is used to support the magnet to increase stability. After being attracted, the nail is positioned along the centerline of the sleeve so it becomes more convenient to use the nail attracting device.

### BACKGROUND

Auto hammer are commonly used portable tools. Generally, an auto hammer comprises a housing portion and a nozzle portion connected to the housing portion. The nozzle portion is commonly formed of a hollow cylindrical sleeve with an aperture drilled thereon for accommodating a magnet. The magnet is mounted in the aperture so as to attract the nails arranged in the nozzle portion. One defect for such an auto hammer is that: the magnet is arranged departing from the center of the sleeve and is not parallel to the centerline of the sleeve, that is, the nails are skew after being attracted.

### SUMMARY

An auto hammer comprises a housing body and a nozzle portion connected to the housing body. The housing body contains a striking device therein. The nozzle portion comprises a sleeve and a sleeve support retractable within the sleeve support. The sleeve contains a nail attracting device therein. The nail attracting device comprises a magnet supported by at least one biasing device.

The nail attracting device further comprises a magnetic seat where the magnet is seated and supported by the biasing device.

A V-shaped groove is arranged on the upper surface of the magnetic seat and a slop is arranged on one side of the magnetic seat.

The auto hammer further comprises a cover for enveloping the nail attracting device in the sleeve.

As the nail attracting device is arranged within the sleeve and is supported by the spring, the stability of the auto hammer is increased. Furthermore, as the nail is positioned along the centerline of the sleeve, it becomes more convenient to use the nail attracting device.

### BRIEF DESCRIPTION OF THE DRAWINGS

A better appreciation of the objects, advantages, features, properties, and relationships of the auto hammer disclosed hereinafter will be obtained from the following detailed description and accompanying drawings which set forth illustrative embodiments which are indicative of the various ways in which the principles described hereinafter may be employed.

FIG. 1 is a cut-away view of an auto hammer according to a preferred embodiment of the utility model;

FIG. 2 is a partial exploded schematic view of the auto hammer as illustrated in FIG. 1, illustrating a nozzle portion of the auto hammer;

FIG. 3 is a partial cut-away view of the auto hammer as illustrated in FIG. 1, illustrating the front end of the nozzle portion;

FIG. 4 is a cut-away view of the auto hammer as illustrated in FIG. 1, wherein the auto hammer is in an operating state;

FIG. 5 is a cut-away view of an auto hammer according to another preferred embodiment of the utility model; and

FIG. 6 is a partial exploded schematic view of the auto hammer as illustrated in FIG. 5.

### DETAILED DESCRIPTION

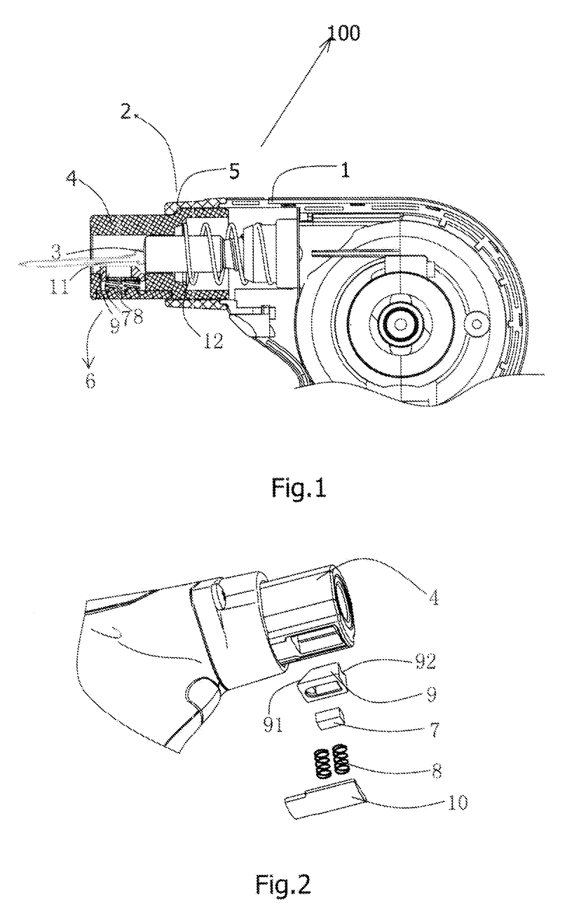

As shown in FIGS. 1 and 2, an auto hammer 100 of a first preferred embodiment of the utility model comprises a housing body 1 and a nozzle portion 2. The nozzle portion 2 is permanently connected to the housing body 1. The housing body 1 contains a striking device 3 therein. The nozzle portion 2 comprises a sleeve 4 and a sleeve support 5. The sleeve 4 is retractable within the sleeve support 5. A nail attracting device 6 is arranged within the sleeve 4 for attracting the nails 11 during operation.

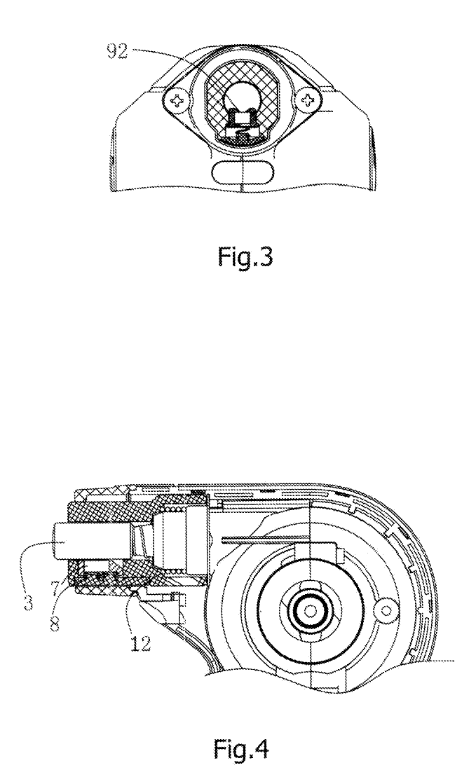

The nail attracting device 6 comprises a magnet 7 supported by a biasing device 8. In the present embodiment, the biasing device 8 is two small springs. The nail attracting device 6 further comprises a magnet seat 9 for holding the magnet 7. As shown in FIGS. 2 and 3, the magnet seat 9 has a V-shaped groove 92 formed on its upper surface and a slope 91 arranged on its one side. Moreover, a cover 10 is provide for enveloping the nail attracting device 6 within the sleeve 4, with the nail attracting device 6 protruding inwards from the inner wall of the sleeve 4.

The magnet 7 is arranged under the V-shape groove 92 of the magnet seat 9, so that the shank portion of the nail 11 could exactly be attracted by the magnet 7 along the V-shape groove. As the nail attracting device 6 is arranged by protruding inwards with respect to the inner walls of the sleeve 4, the nail 11 is positioned substantially along the center line of the center hole of the sleeve 4.

As shown in FIG. 4, the sleeve 4 is retractable into the sleeve support 5 along its axial direction.

During operation, the sleeve is retracted towards the interior of the sleeve support 5 when the front end of the sleeve 4 contacts a wood board. The slop 91 of the magnet seat 9 is pressed by the head of the nail 11 or the striking rod of the striking device 3, and then the nail receiving device 6 goes down to the interior of the wall of the sleeve 4. As a result, both the nail 11 and the striking rod of the striking device 3 pass though the sleeve 4. Subsequently, the sleeve 4 is ejected out under an axial biasing force of an energy storing spring 12 mounted behind the sleeve 4, and then the compression force applied to the nail attracting device 6 by the nail 11 or the striking rod is eliminated, so that the nail attracting device 6 is pushed out of the inner wall of the sleeve 4 via the two small springs 8 and returned hack to its initial state.

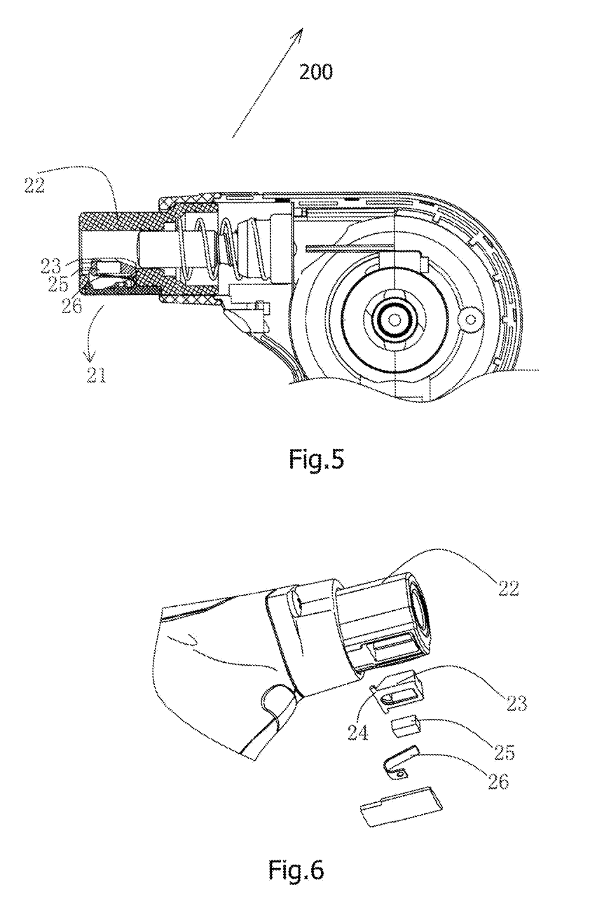

As shown in FIGS. 5 and 6, an auto hammer 200 of a second preferred embodiment of the present utility model is provided, with the descriptions similar to those in the first embodiment will be omitted. The nail attracting device 21 is protruded inwards with respect to the inner wall of the sleeve 22 under a radial biasing force of a leaf spring 26. Similar to the first embodiment, in this embodiment, the nail can also be substantially positioned along the center line of the center hole of the sleeve 22 under the action of a magnet 25. The magnet seat 23 has a round shaft 24 besides a V-shaped groove and a slope, so that it can be rotated via the round shaft 24. With the slope of the magnet seat 23 being forced by the head of the nail or the striking rod, the magnet seat 23 is rotated about the round shaft 24, and then the nail attracting device 21 goes down to the interior of the wall of the sleeve 22. As a result, both the nail and striking rod can pass through the sleeve 22. Subsequently, the sleeve 22 is pushed out under an axial biasing force of an energy storing spring mounted behind the sleeve 4, and then the compression force applied to the nail attracting device by the nail or the striking rod is eliminated, so that the nail attracting device is pushed out of the inner wall of the sleeve 22 via the leaf spring 26 and returned back to its initial state.

The present utility model is not limited to the embodiments described above and the configurations shown in the drawings. Rather, from the description herein, those of skilled in the art will recognize that there are many variations, substitutes and modifications in the shapes and locations of the components that may be made, and such variations, substitutes and modifications all fall in the scope sought for protection in the present invention.

What is claimed is:

1. An auto hammer, comprising:
a housing body containing a striking device therein;
a nozzle portion connected to the housing body, containing a sleeve and a sleeve support;
the sleeve being retractable within the sleeve support and containing a nail attracting device arranged therein;
wherein the nail attracting device comprises a magnet and is supported by at least one spring device.

2. The auto hammer of claim 1, wherein the nail attracting device further comprises a magnetic seat in which the magnet is seated and supported by the spring device.

3. The auto hammer of claim 2, wherein a V-shape groove is formed on the upper surface of the magnetic seat.

4. The auto hammer of claim 3, wherein a slop is formed on one side of the magnetic seat.

5. The auto hammer of claim 4, wherein the spring device comprises two springs.

6. The auto hammer of claim 4, wherein the magnet seat is formed on its one side with a round shaft about which the magnet seat is rotatable.

7. The auto hammer of claim 4, wherein the spring device comprises a leaf spring.

8. The auto hammer of claim 1, further comprising a cover for enveloping the nail attracting device within the sleeve.
